(19) United States
(12) Patent Application Publication
(10) Pub. No.: US 2014/0085737 A1
(43) Pub. Date: Mar. 27, 2014

(54) LENS MODULE AND MANUFACTURING METHOD THEREOF

(71) Applicant: SAMSUNG ELECTRO-MECHANICS CO., LTD., Suwon (KR)

(72) Inventors: Hye Ran OH, Suwon (KR); Young Su Jin, Suwon (KR); Won Kyu Son, Suwon (KR); Yong Joo Jo, Suwon (KR); In Cheol Chang, Suwon (KR)

(73) Assignee: SAMSUNG ELECTRO-MECHANICS CO., LTD., Suwon (KR)

(21) Appl. No.: 13/739,317

(22) Filed: Jan. 11, 2013

(30) Foreign Application Priority Data
Sep. 21, 2012 (KR) 10-2012-0105296

(51) Int. Cl. G02B 13/00; G02B 9/10; G02B 7/02; G02B 3/00

(52) U.S. Cl. CPC G02B 13/004; G02B 3/00; G02B 9/10; G02B 7/021
USPC 359/715; 359/793; 359/795; 264/1.7

(57) ABSTRACT

There are provided a lens module and a manufacturing method thereof allowing for a reduction in a total length of the lens module. The lens module include: a first lens, a cross section of which, perpendicular to an optical axis, is circular; and a second lens, a cross section of which, perpendicular to an optical axis, is quadrangular.

### CROSS-REFERENCE TO RELATED APPLICATIONS

This application claims the priority of Korean Patent Application No. 10-2012-0105296 filed on Sep. 21, 2012, in the Korean Intellectual Property Office, the disclosure of which is incorporated herein by reference.

### BACKGROUND OF THE INVENTION

1. Field of the Invention

The present invention relates to a lens module configured of one or more lenses and a manufacturing method thereof, and more particularly, to a lens module having a relatively short optical axis, and a manufacturing method thereof.

2. Description of the Related Art

A lens module is commonly mounted in various portable terminals including cellular phones and portable computers (such as laptop computers). Further, in accordance with improvements in portable terminal performance, lens module performance has also improved.

The performance of a lens module is generally in proportion to the number of lenses included therein. However, when the number of lenses included in a lens module is increased, a length of the lens module (length in an optical axis) may be increased to make miniaturization or thinness of the portable terminal difficult. Therefore, the development of a lens module that does not affect the miniaturization or the thinning of a portable terminal has been demanded.

Meanwhile, Patent Documents 1 and 2 are provided as related art. Patent Document 1 discloses a configuration of forming a lens using a polymer material on a thin wafer, while Patent Document 2 discloses a configuration of aligning a plurality of lenses in an optical axis direction.

However, since these Patent Documents do not disclose any configuration for decreasing a length of the lens module, they may not solve the above-mentioned problems.

### RELATED ART DOCUMENT

(Patent Document 1) KR2008-004201 A
(Patent Document 2) JP2004-088713 A

### SUMMARY OF THE INVENTION

An aspect of the present invention provides a lens module and a manufacturing method thereof allowing for a significant reduction in a length of the lens module.

According to an aspect of the present invention, there is provided a lens module including: a first lens having a circular cross section, perpendicular to an optical axis; and a second lens having a quadrangular cross section, perpendicular to an optical axis.

The first lens may include a gate cut part.

The first lens may be manufactured by an injection molding method, and the second lens may be manufactured by a casting method.

The second lens may have a thickness of 200 μm or less on a thinnest portion thereof.

The first lens may have positive refractive power, and the second lens may have negative refractive power.

The first lens may include a first coupling unit, the second lens may include a second coupling unit, and the first lens and the second lens may be aligned by coupling the first and second coupling units.

The first coupling unit may be a first protrusion or a first groove, and the second coupling unit may be a second groove corresponding to the first protrusion or a second protrusion corresponding to the first groove.

According to another aspect of the present invention, there is provided a lens module including: a first lens having positive or negative refractive power; a second lens having refractive power different from that of the first lens; a third lens having positive or negative refractive power; and a fourth lens having at least two inflection points formed on at least one of an object-side surface and an image-side surface thereof, wherein at least one lens having negative refractive power among the lenses has a thickness of 200 μm or less on a central portion thereof based on an optical axis.

The lens having negative refractive power may be manufactured by a casting method.

A lens having positive refractive power among the lenses may be manufactured by an injection molding method.

A cross section of the lens having negative refractive power perpendicular to the optical axis may be quadrangular.

The lens having negative refractive power may have a gate cut part.

The lenses include protrusions and grooves formed on and in surfaces thereof facing each other so as to be easily aligned in an optical axis direction.

According to another aspect of the present invention, there is provided a method of manufacturing a lens module, including: manufacturing a first lens by a first method; manufacturing a second lens by a second method; and aligning an optical axis of the first lens and an optical axis of the second lens.

The first method may be an injection molding method, and the second method may be a casting method.

The first lens may have positive refractive power, and the second lens may have negative refractive power.

The method may further include manufacturing a third lens by any one of the first and second methods, and aligning an optical axis of the third lens with the optical axis of the second lens.

The method may further include applying an adhesive between the first lens and the second lens.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of a lens module according to an embodiment of the present invention;

FIG. 2 is an assembled cross-sectional view of the lens module shown in FIG. 1;

FIG. 3 is an exploded perspective view of a lens module according to another embodiment of the present invention;

FIG. 4 is an assembled cross-sectional view of the lens module shown in FIG. 3;

FIGS. 5 and 6 are schematic perspective views of a second lens for describing another form of a groove shown in FIG. 3;

FIG. 7 is an exploded perspective view of a lens module according to another embodiment of the present invention;

FIG. 8 is an assembled plan view of the lens module shown in FIG. 7;

FIGS. 9 through 13 are views for describing other forms of a first lens;

FIG. 14 is a configuration diagram of a lens module according to another embodiment of the present invention;

FIG. 15 is a view showing a modulation transfer function (MTF) curve of the lens module shown in FIG. 14; and

FIG. 16 is a view showing an MTF curve of a lens module according to the prior art.

### DETAILED DESCRIPTION OF THE EMBODIMENTS

As demand for miniaturization of a lens module has increased, the development of a lens module having a relatively short optical axis distance (a distance (unit: mm) from an object-side surface of a lens closest to an object to an image-side surface of a lens closest to an image sensor) while maintaining lens performance, has been attempted. For example, an effort to make lenses thin in order to decrease a total length of the lens module has been conducted. However, since the lenses of the lens module are generally manufactured by an injection molding method, there is a limitation in making the lenses of 250 μm or less.

Meanwhile, as another method of manufacturing lenses, provided is a casting method. Since the casting method is a scheme of molding a plurality of lenses using a mold, lenses may be mass-produced and may be manufactured to be relatively thin. However, since lenses manufactured by the casting method are of lower quality than lenses manufactured by the injection molding method, it is difficult for the lenses manufactured by the casting method to be used for a lens module having high resolution.

The present invention, which considers all of the above-mentioned problems, is characterized in that a lens module is configured of lenses manufactured through different manufacturing methods. For example, according to an embodiment of the present invention, a lens requiring relatively high quality is manufactured by the injection molding method, and a lens requiring relatively low quality is manufactured by the casting method, whereby the lens module may be thinned. Therefore, the lens module according to the embodiment of the present invention may have a relatively short optical axis distance while having the same lens performance.

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

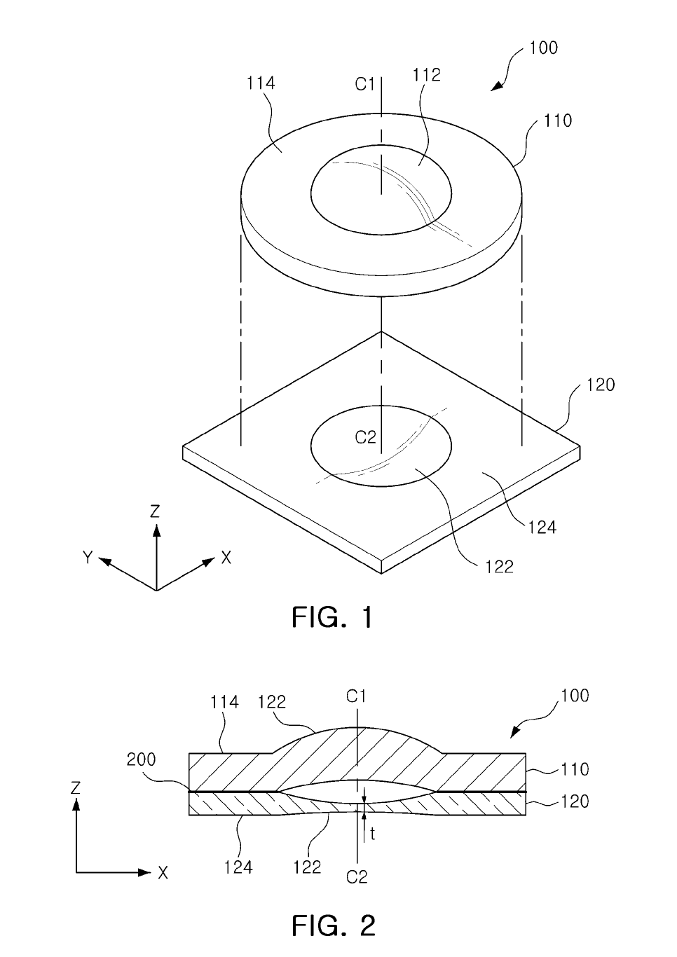

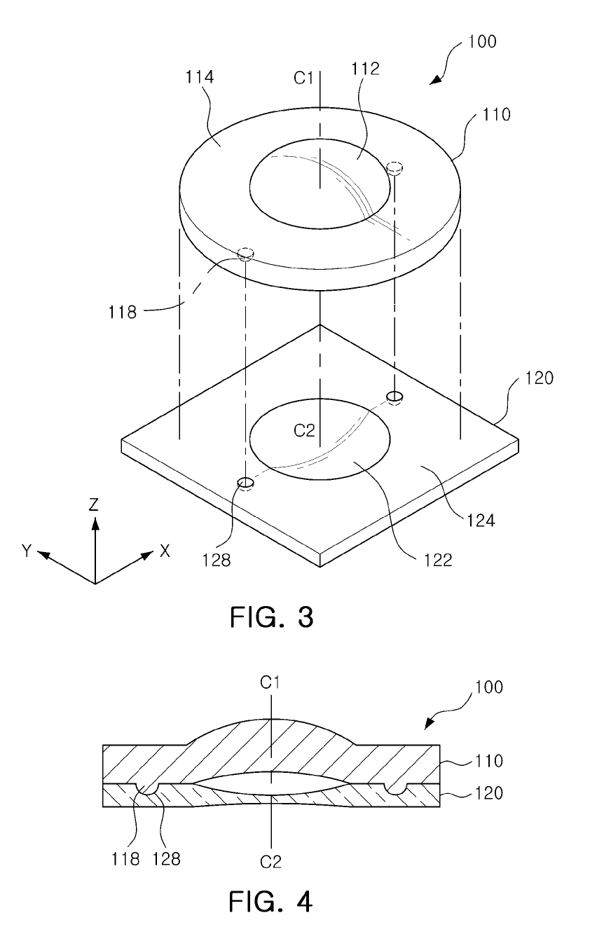

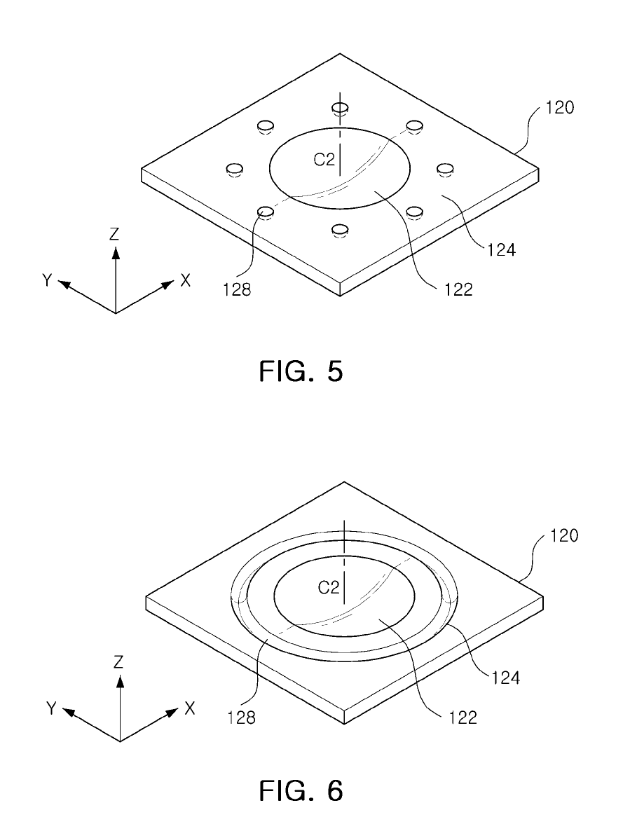

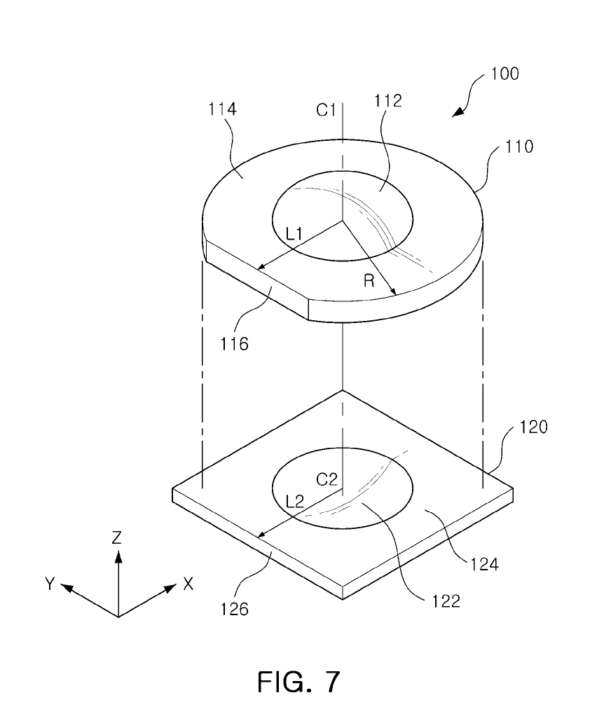

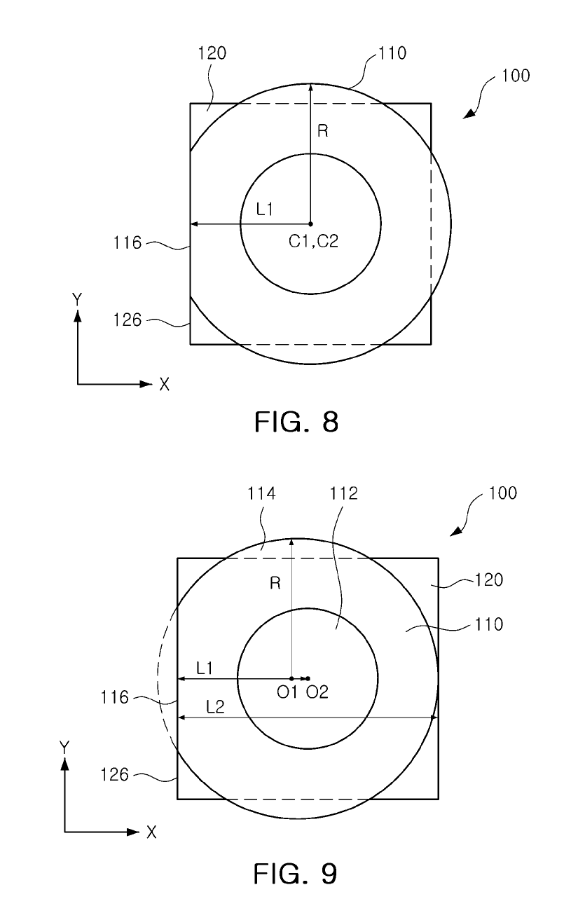

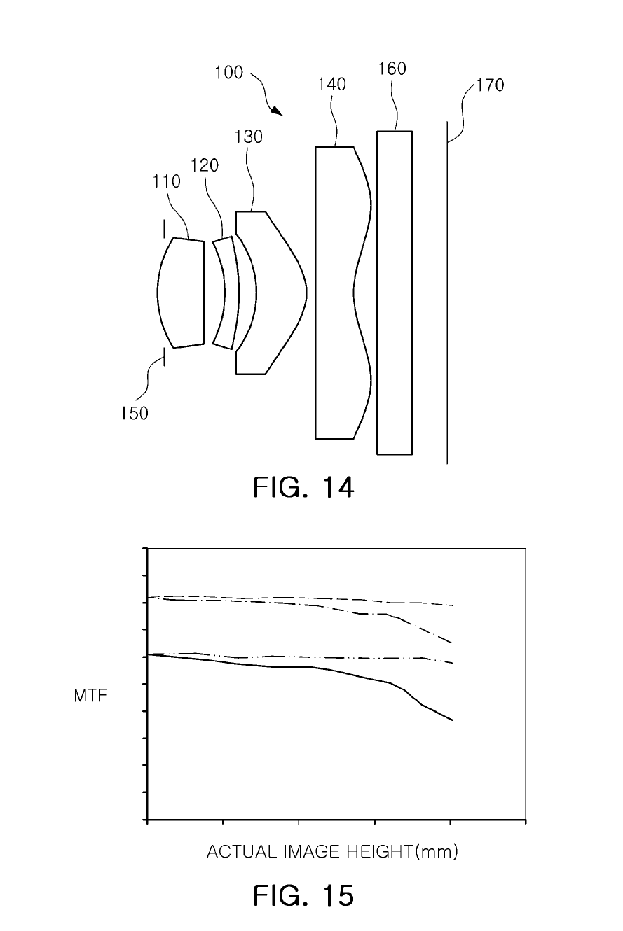

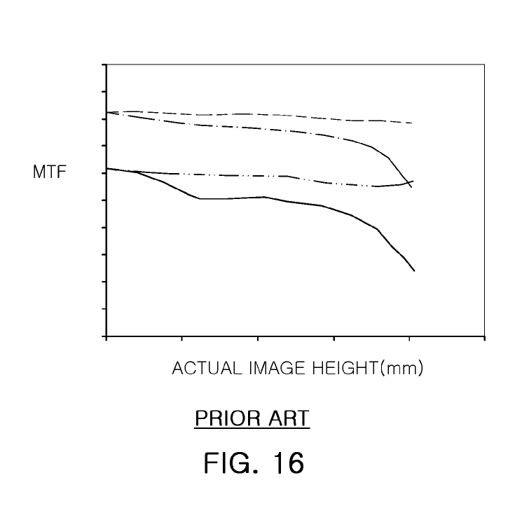

FIG. 1 is an exploded perspective view of a lens module according to an embodiment of the present invention; FIG. 2 is an assembled cross-sectional view of the lens module shown in FIG. 1; FIG. 3 is an exploded perspective view of a lens module according to another embodiment of the present invention; FIG. 4 is an assembled cross-sectional view of the lens module shown in FIG. 3; FIGS. 5 and 6 are schematic perspective views of a second lens for describing another form of a groove shown in FIG. 3; FIG. 7 is an exploded perspective view of a lens module according to another embodiment of the present invention; FIG. 8 is an assembled plan view of the lens module shown in FIG. 7; FIGS. 9 through 13 are views for describing other forms of a first lens; FIG. 14 is a configuration diagram of a lens module according to another embodiment of the present invention; FIG. 15 is a view showing a modulation transfer function (MTF) curve of the lens module shown in FIG. 14; and FIG. 16 is a view showing an MTF curve of a lens module according to the related art.

A lens module according to an embodiment of the present invention will be described with reference to FIGS. 1 and 2.

The lens module 100 may include a first lens 110 and a second lens 120.

The first lens 110 may be formed of plastic or resin. More specifically, the first lens 110 may be formed of a photocurable material or a thermosetting material. However, the first lens 110 is not limited to being formed of plastic or resin, and may be formed of glass as required.

A cross section of the first lens 110 perpendicular to an optical axis C1 may be circular. In the first lens 110 having the above-mentioned shape, since distances from the optical axis C1 to an edge thereof are the same, it may be easy to align the optical axis of the lens.

The first lens 110 may have an optical part 112 and a light shielding part 114.

The optical part 112 may be a part at which incidence and refraction of light are substantially made and have a generally convex or concave shape. More specifically, the optical part 112 may have two convex surfaces, two concave surfaces, or a meniscus shape. In addition, the optical part 112 may have a spherical surface or an aspherical surface. The optical part 112 having the above-mentioned shape may have positive refractive power or negative refractive power as required.

The light shielding part 114 may shield unnecessary light and have a generally flat surface. The light shielding part 114 formed as described above may enable adhesion and alignment of lenses. For example, the light shielding part 114 may have an adhesive 200 applied thereto so that the lenses may be adhered to each other.

The first lens 110 configured as described above may be manufactured by an injection molding method. Since the first lens manufactured by the injection molding method may be precisely molded, it may be appropriate for use as a lens requiring high quality. For example, the first lens 110 may be used as an object-side lens closest to an object in the lens module.

The second lens 120 may be formed of plastic or resin. More specifically, the second lens 120 may be formed of a photocurable material or a thermosetting material. However, the second lens 120 is not limited to being formed of plastic or resin, but may be formed of glass as required.

A cross section of the second lens 120, perpendicular to an optical axis C2, may be quadrangular (more specifically, a square shape). The second lens 120 having the above-mentioned shape may be obtained by cutting a lens array.

The second lens 120 may have an optical part 122 and a light shielding part 124.

The optical part 122 may be a part at which incidence and refraction of light are substantially made and have a generally convex or concave shape. More specifically, the optical part 122 may have two convex surfaces, two concave surfaces, or a meniscus shape. In addition, the optical part 122 may have a spherical surface or an aspherical surface. The optical part 122 having the above-mentioned shape may have positive refractive power or negative refractive power as required.

The light shielding part 124 may shield unnecessary light and have a generally flat surface. The light shielding part 124 formed as described above may enable adhesion and alignment of lenses. For example, the light shielding part 124 may have an adhesive 200 applied thereto so that the lenses may be adhered to each other.

The second lens 120 configured as described above may be manufactured by a casting method. The second lens 120 manufactured by the casting method may have a thickness t thinner than that of the lens manufactured by the injection molding method. For example, a thickness of the thinnest portion (an optical axis portion in FIG. 2) of the second lens 120 may be 200 μm or less. Therefore, the second lens 120 may decrease the total optical axis length (TL) of the lens module 100.

Meanwhile, the case in which the first lens 110 is manufactured by the injection molding method and the second lens 120 is manufactured by the casting method has been described in the present embodiment. However, the methods of manufacturing the first and second lenses 110 and 120 may be changed according to types of lens modules.

Hereinafter, other embodiments of the present invention will be described. For reference, in describing other embodiments of the present invention, components that are the same as those of the previous embodiment of the present invention will be denoted by the same reference numerals and a detailed description thereof will be omitted.

A lens module according to another embodiment of the present invention will be described with reference to FIGS. 3 through 6.

The lens module 100 according to this embodiment of the present invention is different from the lens module 100 according to the previous embodiment of the present invention in a coupling structure of the first and second lenses 110 and 120.

The first lens 110 and the second lens 120 may include a coupling unit for optical axis alignment and mutual coupling. More specifically, the first lens 110 may have a plurality of protrusions 118, and the second lens 120 may have a plurality of grooves 128.

The protrusions 118 may be formed on a lower surface of the first lens 110. More specifically, the protrusions 118 may be formed on the light shielding part 114 of the first lens 110 and protrude toward the second lens 120.

The grooves 128 may be formed in an upper surface of the second lens 120. More specifically, the grooves 128 may be formed in the light shielding part 124 of the second lens 120 and receive the protrusions 118 of the first lens 110 therein.

The protrusions 118 and the grooves 128 formed as described above may stably couple the first lens 110 and the second lens 120 and allow the optical axis C1 of the first lens 110 and the optical axis C2 of the second lens 120 to be positioned on the same line.

Meanwhile, the plurality of grooves 128 of the second lens 120 may be arranged in a circular manner based on the optical axis C2 as shown in FIG. 5. Alternatively, a single groove 128 of the second lens 120 may be formed to have an annular shape based on the optical axis C2 as shown in FIG. 6. Here, it will be obvious to those skilled in the art that the protrusion 118 of the first lens 110 may be disposed in the same manner as the groove 128 shown in FIGS. 5 and 6.

For reference, although the case in which the protrusion is formed on the first lens 110 and the groove is formed in the second lens 120 has been described in the above-mentioned embodiment, positions of the protrusions and the grooves may be changed as required. For example, the groove may be formed in the first lens 110 and the protrusion may be formed on the second lens 120.

Hereinafter, a lens module according to another embodiment of the present invention will be described with reference to FIGS. 7 through 13.

The lens module 100 according to this embodiment of the present invention may further include a gate cut part 116.

In the lens manufactured by the injection molding method, a gate shape may remain due to a gate through which a molding material is injected. The gate shape may hinder insertion of the lens into a housing. In the present embodiment, which considers this point, the gate cut part 116 may be formed in the first lens 110.

The gate cut part 116 may be formed in one side of the first lens 110 and may be a plane parallel with the optical axis C1.

The optical axis C1 of the first lens 110 may be maintained so as to be spaced apart from the gate cut part 116 by a predetermined distance L1 (hereinafter, referred to as a first distance). Here, the first distance L1 may be smaller than a radius R of the first lens 110 and may be the same as a distance L2 (hereinafter, referred to as a second distance) from the optical axis C2 of the second lens 120 to a first side 126 thereof.

In the lens module 100 configured as described above, the gate cut part 116 of the first lens 110 and the first side 126 of the second lens 120 are aligned to thereby allow the optical axes C1 and C2 to coincide (See FIG. 8).

Meanwhile, when the gate cut part is formed in the lens (the first lens 110 in the present embodiment) manufactured by the injection molding method, the lens may have an asymmetrical shape. The lens having the asymmetrical shape may cause an asymmetrical contraction phenomenon in a cooling process after being injection molded, which may change a position of an optical axis of the lens.

In the present embodiment, in order to solve this problem, the first lense 110 may be provided to have various shapes. FIGS. 9 through 11 show modified forms of the first lens 110 for significantly decreasing the asymmetrical contraction phenomenon.

In the first lens 110 shown in FIG. 9, a center O2 of the optical part 112 and a center O1 of the light shielding part 114 are different from each other. More specifically, the center O2 of the optical part 112 is spaced apart from the gate cut part 116 by the first distance L1. Here, the first distance L1 may be half of a distance L3 from the gate cut part 116 to an edge of the first lens 110.

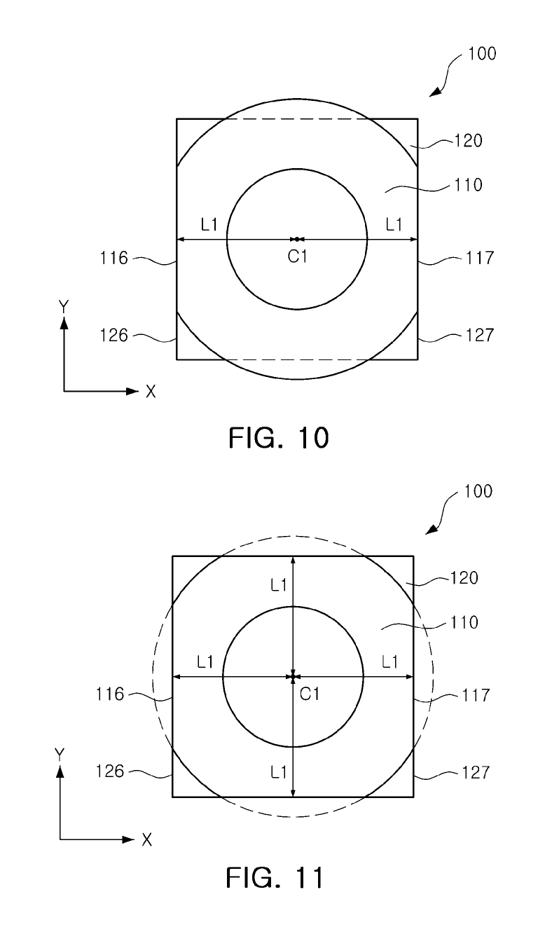

The first lens 110 shown in FIG. 10 may include the gate cut part 116 and an auxiliary cut part 117. Here, the auxiliary cut part 117 may be symmetrical with regard to the gate cut part 116 based on the optical axis C1. In addition, a distance from the optical axis C1 to the gate cut part 116 and a distance from the optical axis C1 to the auxiliary cut part 117 may be L1, that is, may be the same as each other.

In the first lens 110 having the above-mentioned shape, since the gate cut part 116 and the auxiliary cut part 117 are provided to be symmetrical with regard to each other, the asymmetrical contraction phenomenon of the lens may be significantly decreased, and a phenomenon in which the position of the optical axis C1 is changed while the lens is contracted may be significantly decreased.

Here, the gate cut part 116 and the auxiliary cut part 117 of the first lens 110 may be aligned to coincide with first and second sides 126 and 127 of the second lens 120, respectively, in a state in which the first lens 110 and the second lens 120 are adhered to each other.

The first lens 110 shown in FIG. 11 may include the gate cut part 116 and auxiliary cut parts 117. Here, distances from the optical axis C1 to the gate cut part 116 and to the respective auxiliary cut parts 117 may be L1, that is, may be the same as one another. The first lens 110 having this shape may be easily aligned with the second lens 120 having a quadrangular cross-sectional shape.

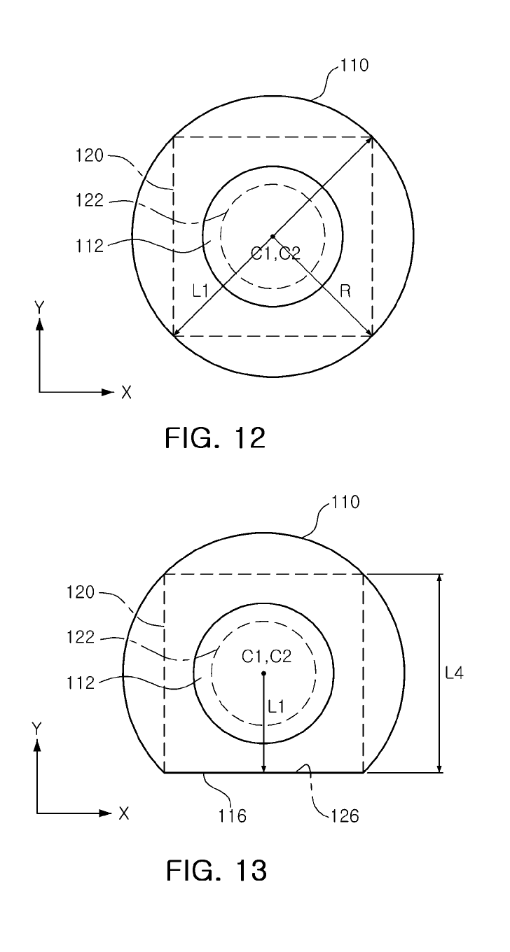

Meanwhile, in the case in which a lens barrel or a housing is manufactured so as to be appropriate for a size of the first lens 110, the second lens 120 may be manufactured to have a size smaller than that of the first lens 110, as shown in FIGS. 12 and 13. In this case, there is an advantage that both of the first lens 110 and the second lens 120 may be mounted in the lens barrel having a circular cross section.

For example, a diagonal length L4 of the second lens 120 may be equal to or smaller than a diameter (2×R) of the first lens 110. In this case, an edge of the first lens 110 and a corner of the second lens 120 are aligned, whereby the optical axis C1 of the first lens 110 and the optical axis C2 of the second lens 120 may easily coincide. Further, in this case, since a maximum length L4 of the second lens 120 is equal to the diameter (2×R) of the first lens 110, the second lens 120 may be easily inserted into the lens barrel for the first lens 110.

Meanwhile, the first lens 110 may include the gate cut part 116 as described above. In this case, the gate cut part 116 may coincide with the first side 126 of the second lens 120. More specifically, a length L5 of the gate cut part 116 may be the same as a length L6 of one side of the second lens 120 having a quadrangular shape (See FIG. 13). In addition, a length L1 from the optical axis C1 of the first lens 110 to the gate cut part 116 may be half of the length L6 of one side of the second lens 120 having the quadrangular shape.

According to the above-mentioned configuration, the gate cut part 116 and the first side 126 of the second lens 120 are aligned, whereby the optical axis C1 of the first lens 110 and the optical axis C2 of the second lens 120 may coincide.

Hereinafter, a method of manufacturing a lens module according to an embodiment of the present invention will be described.

The method of manufacturing a lens module according to the present embodiment may include manufacturing a first lens, manufacturing a second lens, and aligning the first lens and the second lens, and may further include adhering the first lens and the second lens to each other.

1) Manufacturing First Lens

A first lens is manufactured. In the present operation, the first lens may be manufactured by an injection molding method. In the first lens manufactured by the injection molding method, a cross section of the first lens perpendicular to an optical axis may be circular.

The present operation may include a gate cutting process. That is, the present operation may include cutting a gate formed on one surface of the first lens in an injection molding process.

2) Manufacturing Second Lens

A second lens is manufactured. In the present operation, the second lens may be manufactured by a casting method. A cross section of the second lens manufactured by the casting method, perpendicular to an optical axis, may be quadrangular.

3) Aligning First and Second Lenses

The first lens and the second lens are aligned. More specifically, in the present operation, the optical axis of the first lens and the optical axis of the second lens are aligned. Here, the first and second lenses may be aligned by using coupling units (for example, protrusions and grooves) each formed on and in the first lens and the second lens or by allowing the gate cut part of the first lens and a side of the second lens to coincide on the same plane.

4) Adhering First and Second Lenses to Each Other

The aligned first and second lenses are adhered to each other. Here, an adhesive may be applied to at least one of a light shielding part of the first lens and a light shielding part of the second lens.

Hereinafter, a lens module according to another embodiment of the present invention will be described with reference to FIGS. 14 and 15. For reference, FIG. 16 is a view showing a modulation transfer function (MTF) curve of a lens module according to the related art having a configuration similar to that of the lens module shown in FIG. 14.

The lens module 100 according to the present embodiment may include a first lens 110, a second lens 120, a third lens 130, and a fourth lens 140, and may optionally further include an aperture stop 150, a filter member 160, and an image sensor 170. The first to fourth lenses 110 to 140 may be sequentially disposed from an object side (that is, an object or an imaging target) to an image side (that is, an image sensor).

All of the first lens 110, the second lens 120, the third lens 130, and the fourth lens 140 may be formed of plastic. When all of the first to fourth lenses 110, 120, 130, and 140 are made of plastic as described above, manufacturing costs of the lens module 100 may be decreased, and the lens module 100 may be mass-produced. In addition, when all of the first to fourth lenses 110, 120, 130, and 140 are made of plastic, since a lens surface is easily processed, the lens surface may be formed as a spherical surface or an aspherical surface.

The filter member 160 may be disposed at the rear side of the fourth lens 140. Both surfaces of the filter member 160 may be flat and may be formed of a material other than plastic. For example, the filter member 160 may be formed of glass.

The filter member 160 may filter infrared light. To this end, the filter member 160 may have an infrared (IR) shielding film attached to at least one surface thereof or an IR shielding coating coated on at least one surface thereof. Meanwhile, the filter member 160 may be omitted according to types of lens modules.

The image sensor 170 may be disposed at the rear side of the filter member 160.

The image sensor 170 may convert an image of the object incident through the first to fourth lenses 110, 120, 130, and 140 into an electrical signal. As the image sensor 170, a charged coupled device (CCD) or a complementary metal oxide semiconductor (CMOS) image sensor may be used. In addition, the image sensor 170 may be manufactured in a chip scale package (CSP) form.

The aperture stop 150 may be disposed at the front side of the first lens 110 or be disposed between the first lens 110 and the second lens 120. However, the aperture stop may be omitted as required.

Meanwhile, most of the lenses configuring the lens module 100 may be manufactured by the injection molding method. However, at least one lens may be manufactured by the casting method. In the present embodiment, the second lens 120 having negative refractive power is manufactured by the casting method. However, a lens manufactured by the casting method is not limited to the second lens 120, but the first lens or other lenses may be manufactured by the casting method as required.

The lens module 100 configured as described above may decrease a total optical length. Table 1 shows comparison results between numerical values of the lens module 100 according to the present embodiment and the lens module according to the related art. Here, both of the lens module 100 according to the present embodiment and the lens module according to the related art are configured of four lenses, each of which may have the same shape and refractive power.

TABLE 1

| | Present | |
|---|---|---|
| Remark | Embodiment | Related Art |
| Thicknesses of Respective Lenses | 0.426/0.13/0.442/ | 0.426/0.23/0.406/ |
| (first/second/third/fourth lenses) | 0.327 | 0.328 |
| Image Height [mm] | 1.61 | 1.61 |
| F No. | 2 | 2 |
| Field of View (FOV) | 76.5° | 76.5° |
| Total Optical Axis Length | 2.68 | 2.73 |

As seen in Table 1, the lens module 100 according to the present embodiment may have substantially the same performance as that of the lens module according to the related art. That is, characteristics of the lens module 100 according to the present embodiment, such as an image height, F No., a field of view, and the like, are the same as those of the lens module according to the related art.

On the other hand, a thickness of the second lens 120 of the lens module 100 according to the present embodiment is 0.13 mm, which is smaller than 0.23 mm, a thickness of the second lens of the lens module according to the related art. Even though a thickness of the third lens 130 is increased as compared with the related art, while the thickness of the second lens 120 is decreased, the total optical axis length of the lens module is 2.68 mm, which is shorter than 2.73 mm, the total optical axis length of the lens module according to the related art.

Therefore, according to the present embodiment, the total optical axis length is decreased while the same performance of the lens module is implemented, whereby the lens module may be thinned.

Meanwhile, the second lens 120 according to the present embodiment may have an excellent MTF performance. That is, since a central portion of the second lens 120 according to the present embodiment is excessively thin, 132 μm, a change range of an actual image height at a peripheral portion of the lens is not high, as shown in FIG. 15.

On the other hand, since a central portion of the second lens according to the related art is relatively thick, 230 μm, an actual image height is relatively rapidly changed at a peripheral portion of the lens, as shown in FIG. 16.

Therefore, it is obvious that the lens module 100 according to the present embodiment may have more excellent optical characteristics than those of the lens module according to the related art.

As set forth above, according to embodiments of the present invention, since a total length of a lens module is decreased, the lens module may be miniaturized.

While the present invention has been shown and described in connection with the embodiments, it will be apparent to those skilled in the art that modifications and variations can be made without departing from the spirit and scope of the invention as defined by the appended claims.

What is claimed is:

1. A lens module comprising:
a first lens having a circular cross section, perpendicular to an optical axis; and
a second lens having a quadrangular cross section, perpendicular to an optical axis.

2. The lens module of claim 1, wherein the first lens includes a gate cut part.

3. The lens module of claim 1, wherein the first lens is manufactured by an injection molding method, and
the second lens is manufactured by a casting method.

4. The lens module of claim 1, wherein the second lens has a thickness of 200 μm or less on a thinnest portion thereof.

5. The lens module of claim 1, wherein the first lens has positive refractive power, and
the second lens has negative refractive power.

6. The lens module of claim 1, wherein the first lens includes a first coupling unit,
the second lens includes a second coupling unit, and
the first lens and the second lens are aligned by coupling the first and second coupling units.

7. The lens module of claim 6, wherein the first coupling unit is a first protrusion or a first groove, and
the second coupling unit is a second groove corresponding to the first protrusion or a second protrusion corresponding to the first groove.

8. A lens module comprising:
a first lens having positive or negative refractive power;
a second lens having refractive power different from that of the first lens;
a third lens having positive or negative refractive power; and
a fourth lens having at least two inflection points formed on at least one of an object-side surface and an image-side surface thereof,
wherein at least one lens having negative refractive power among the lenses has a thickness of 200 μm or less on a central portion thereof based on an optical axis.

9. The lens module of claim 8, wherein the lens having negative refractive power is manufactured by a casting method.

10. The lens module of claim 8, wherein a lens having positive refractive power among the lenses is manufactured by an injection molding method.

11. The lens module of claim 8, wherein a cross section of the lens having negative refractive power perpendicular to the optical axis is quadrangular.

12. The lens module of claim 8, wherein the lens having negative refractive power has a gate cut part.

13. The lens module of claim 8, wherein the lenses include protrusions and grooves formed on and in surfaces thereof facing each other so as to be easily aligned in an optical axis direction.

14. A method of manufacturing a lens module, comprising:
manufacturing a first lens by a first method;
manufacturing a second lens by a second method; and
aligning an optical axis of the first lens and an optical axis of the second lens.

15. The method of claim 14, wherein the first method is an injection molding method, and
the second method is a casting method.

16. The method of claim 14, wherein the first lens has positive refractive power, and
the second lens has negative refractive power.

17. The method of claim 14, further comprising:
manufacturing a third lens by any one of the first and second methods; and
aligning an optical axis of the third lens with the optical axis of the second lens.

18. The method of claim 14, further comprising applying an adhesive between the first lens and the second lens.
